(19) United States
(12) Patent Application Publication
(10) Pub. No.: US 2016/0110682 A1
(43) Pub. Date: Apr. 21, 2016

(54) ELECTRONIC PLATFORM

(71) Applicants: HON SENG TEH, PUCHONG (MY); CHUN KET CHAI, PUCHONG (MY)

(72) Inventors: HON SENG TEH, PUCHONG (MY); CHUN KET CHAI, PUCHONG (MY)

(21) Appl. No.: 14/882,082

(22) Filed: Oct. 13, 2015

(30) Foreign Application Priority Data
Oct. 16, 2014 (MY) PI 2014703080

(51) Int. Cl. G06Q 10/08; H04W 72/04; H04W 68/00

(52) U.S. Cl. CPC G06Q 10/087; H04W 68/00; H04W 72/0453

(57) ABSTRACT

An electronic platform system includes: at least one cloud database connected to a communication network; a store platform connected to cloud database via the communication network, configured to display a list of products and/or services for a user to select; a payment platform connected to the store platform via the communication network, configured to allow the user to make a purchase directly from the store platform; and an application server connected to the cloud database via the communication network.

### CROSS-REFERENCE TO RELATED APPLICATION

The instant application claims priority to Malaysian Patent Application No. PI 2014703080, filed Oct. 16, 2014, the entire specification of which is expressly incorporated herein by reference.

### FIELD OF INVENTION

The invention relates to surveillance system. More particularly, the invention relates to an electronic platform for use in a video surveillance system and method thereof.

### BACKGROUND OF THE INVENTION

Typically, a surveillance camera has the ability of recoding and sending out video signals. However, it does not have the ability to communicate with another device such as a mobile device, computer, television, etc. To acquire such ability, the camera and the device must be connected to a platform that acts as a translator to facilitate a communication link between the camera and the device so that the video signals can be transferred from the camera to the other device.

There are a few patented technologies of the prior art relating to the above mentioned platform. Of interest in respect to a network video surveillance system and recorder is WO2010045404A2. The patent discloses a video surveillance method and system controls and distributes video signals from multiple surveillance cameras to multiple video clients by receiving a single original video signal stream from a camera and simultaneously converting it to a plurality of video streams, with each video stream having a different video quality parameter. The different quality parameters may be different resolutions, degrees of compression, different frame rates, presence or absence of color, intensity of color, different contrast levels and different brightness levels. The video clients are entitled to access specified video quality parameters, and are simultaneously sent the converted video streams with the different video quality parameter to which they are entitled to access.

Another apparatus for cloud based operating and virtual file system is disclosed in U.S. Pat. No. 8,527,549B2. The patent provides a method for managing a virtual distributed file system includes maintaining by a master device located in a cloud computing environment, a metadata data structure that stores metadata about locations of most updated versions of multiple file portions and security levels of the file portions, at least one file portion being stored at a user device coupled to the cloud computing environment, and maintaining by the master device, transaction of file portions to user entities, at least one user entity being hosted by the user device, based on at least metadata stored in the metadata data structure about the file portions.

The main drawback of those systems is a lack of compatibility of different camera types, video formats, and operating software of the cameras or devices. Due to the compatibility issue, users of the systems may not able to view the video signal in real time or to retrieve the video data from the systems. Furthermore, the systems do not provide a remote controlling element that is crucial if the camera is needed to be remotely adjusted. In addition, the occurrence of false alarm alerts is frequent as the prior systems are not able to recognize a detected person or event. Therefore, a need exist for the prior systems to be improved and this invention provides such a system and method thereof.

### SUMMARY OF INVENTION

The present invention provides an electronic platform system, including: at least one cloud database connected to a communication network; a store platform connected to the cloud database via the communication network, configured to display a list of products and/or services for a user to select; a payment platform connected to the store platform via the communication network, configured to allow the user to make a purchase directly from the store platform; and an application server connected to the cloud database via the communication network, wherein the application server comprises: a camera module configured to communicate with at least one camera, retrieve visual and/or audio data from the camera, store the visual and/or audio data in the cloud database, a codec processing unit for encoding or decoding the stored visual and/or audio data, and a web server for a computing device of the user to retrieve or display the stored visual and/or audio data from the cloud database or display the visual and/or audio data directly from the camera in real time.

Preferably, the store platform includes a product module for listing a plurality of products and/or services and updating the list of products and/or services.

Advantageously, the payment platform includes a billing module for creating and issuing invoice of each purchase of the user, and a payment module connected to a plurality of third party electronic commerce servers for the user to select a designated third party electronic commerce to proceed with the payment.

Preferably, the web server of the application server includes a website module for managing the template and settings of the website.

Advantageously, the application server further connects to a mobile application that is installed in a mobile device of the user, the mobile application is configured to display visual and/or audio data from the cloud database, to communicate with the application server, and to receive alerts from the application server.

In one embodiment of the invention, the electronic platform further comprises a reseller platform connected to the cloud database and the store platform via the communication network, configured to allow a reseller to resell or manage the listed products and/or services.

In another one embodiment of the invention, the electronic platform further comprises an administrator platform connected to the communication network, configured to manage and/or maintain the system.

In one aspect of the invention, the application server of the electronic platform further includes a cloud service management module for monitoring activities of each server and data space usage of the user.

In another aspect of the invention, the application server of the electronic platform further includes a user module for collecting contextual data of the user in real time.

Yet in another aspect of the invention, the application server of the electronic platform further includes a face recognition module for identifying a person who has been captured by the camera.

Still in another aspect of the invention, the application server of the electronic platform further includes a voice recognition module for identifying the voice of the person who has been captured by the camera.

Yet in another aspect of the invention, the application server of the electronic platform further includes an alert module coupled with the face recognition module or the voice recognition module, configured to send alert message to the mobile device of the user in the event of detecting an unknown person.

Still in another aspect of the invention, the application server of the electronic platform further includes an alarm module connected to at least one alarm system of the user, configured to trigger the alarm system in the event of detecting an unknown person.

Yet in another aspect of the invention, the application server of the electronic platform further includes an ONVIF module configured to automatically detect configurations of the camera, and to allow the user to remotely control the camera.

Still in another aspect of the invention, the application server of the electronic platform further includes a motion detector unit coupled with the ONVIF module, configured to transform the camera into a motion detector for detecting movements.

Yet in another aspect of the invention, the application server of the electronic platform further includes a data overwrite module configured to overwrite the stored visual and/or audio data with the newly retrieved visual and/or audio data.

Still in another aspect of the invention, the application server of the electronic platform further includes a social network module connected to a plurality of social networks, configured to allow the user to upload the retrieved visual and/or audio data to the plurality of social networks, and to display the view of camera in real time.

Yet in another aspect of the invention, the application server of the electronic platform further includes an IP route module configured to detect user IP address, to compare the detected IP address with the camera IP address, and to switch to a localhost based on the comparison.

Still in another aspect of the invention, the application server of the electronic platform further includes a load balancing module for monitoring and optimizing connectivity of the application server with any one of the mobile device, computing device, or camera.

At least one of the preceding objects is met, in whole or in part, by the invention, in which the embodiment of the invention discloses a method for transferring visual and/or audio data comprises the steps of: connecting, by a user, at least one camera to a communication network; configuring, by the user, the communication network to establish a connection between the camera and an application server; inputting, by the user, configurations of the camera to the application server; retrieving, by the application server, visual and/or audio data from the camera and storing the retrieved data into the cloud database; identifying, by the application server, IP address of a computing device of a user who wants to use the camera; and establishing, by the application server, a communication link based on the IP address of the computing device for the computing device to directly use the camera to over look the view of the camera; or transmitting, by the application server, the stored visual and/or audio data to the computing device. Preferably, the configuration of communication network includes port forwarding, Network address translation, Dynamic Domain Name System, and File Transfer Protocol.

In one embodiment of the invention, the method further comprises the steps of identifying, by the application server, a person captured by the camera; and sending an alert message to the computing device of the user in the event of the application server detects an unknown person.

In another embodiment of the invention, the method further comprises the step of activating a connected alarm system of the user in the event of the application server detects an unknown person.

Yet in another embodiment of the invention, the method further comprises the step of remotely controlling the camera upon the request of the user by an ONVIF module of the application server.

Still in another embodiment of the invention, the method further comprises the step of providing a codec processing unit to ensure the visual and/or audio data is displayable.

Yet in another embodiment of the invention, the method further comprises the step of collecting contextual information of the user.

Still in another embodiment of the invention, the method further comprises the step of automatically detecting the configuration of the camera before the step of remotely controlling the camera.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a schematic diagram illustrating an electronic platform to provide cloud based storage, live stream, playback, and notification alerts for a plurality of cameras that embodies therein the principle features of the invention.

FIG. 2 is a flowchart of an illustrative method for connecting the plurality of cameras to the server.

FIG. 3 is a flowchart of an illustrative method for uploading visual or audio data to an application server of the system.

FIG. 4 is a flowchart of an illustrative method for streaming at least one selected camera in real time.

FIG. 5 is a flowchart of an illustrative method for replaying at least one selected camera from a cloud-based database.

### DETAILED DESCRIPTION OF THE INVENTION

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, that execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

The invention will now be described in greater detail, by way of example, with reference to the drawings.

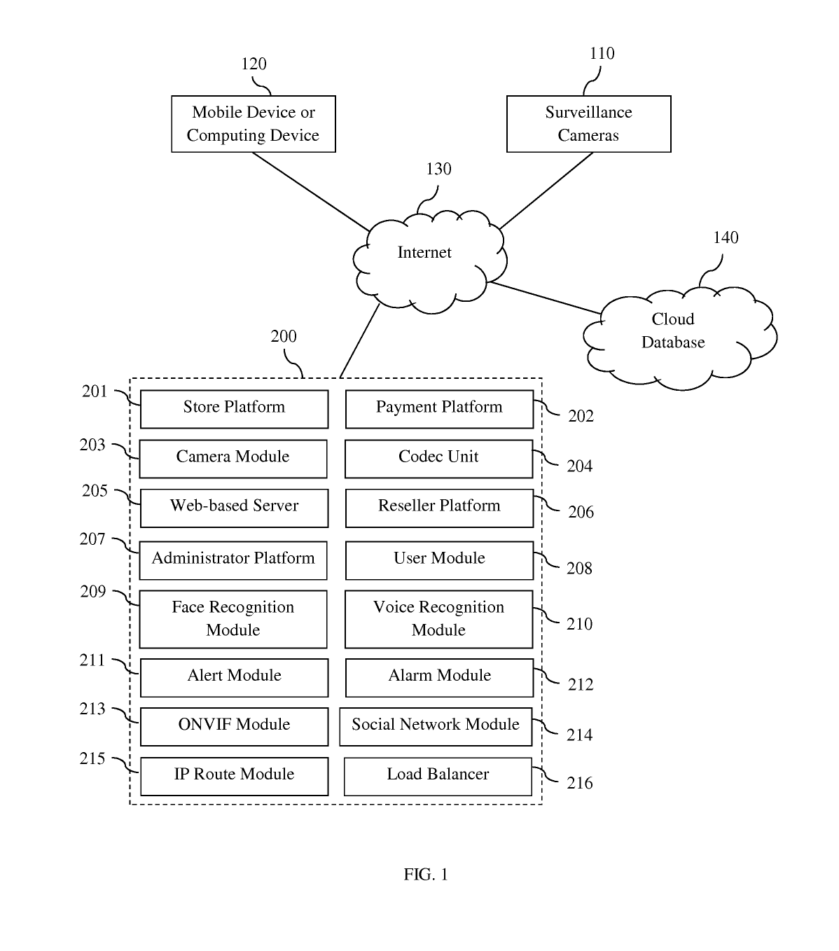

Referring to FIG. 1, an e-commerce electronic platform illustrated therein comprises a plurality of surveillance cameras 110 strategically installed on-site such as house, shopping complex, malls, merchants store, streets, public transport station and/or the like. Preferably, the surveillance cameras 110 are IP cameras or any apparatus that has the functionality of a camera and capable of sending and receiving data via a computer network and the Internet. The surveillance cameras 110 are wireles sly or wiredly connected to an application server 200 (host server) via a communication network 130. Depending on the type of cameras used, the communication network protocol can be implemented in a number of different ways, and incorporating a variety of different network protocols and technologies. The application server 200 is further connected to a cloud database 140 via the communication network 130. Preferably, the cloud database 140 is but not limited to AMAZON Web Services (AWS), DROPBOX, GOOGLE Drive (GDrive), or YOUTUBE. In operation, the user of the system connects their mobile devices or computing devices 120 to the application server 200 to enjoy the services provided by the system.

For sake of convenience, the application server 200 may provide a desktop application or mobile application for the user to download and to install within their devices 120. The application is configured to provide guidance for the user to configure their cameras 110 in a way such that the images of the cameras 110 can be uploaded to the application server 200. The application also allows the user to display the images of selected cameras. Third party applications such as FACEBOOK can be integrated into this application for the user to interactively share or upload the images to the third party application.

In the preferred embodiment of the invention, the application server includes a store platform, a payment platform, a camera module, a codec processing unit, a web-based server, a reseller platform, an administrator platform, a user module, a face recognition module, a voice recognition module, an alert module, an alarm module, an ONVIF module, a social network module, an IP route module, and a load balancing module (201-216).

The store platform 201 has a product module configured to display a list of product and/or services that are provided by the system and to update the list of product and/or services. Furthermore, the store platform 201 can incorporated with an advertising module for purposes of advertising.

The payment platform 202 has a billing module configured to create and issue invoice of product or service purchased by the user. The payment platform 202 can be further linked to a plurality of third party online payment service provider such as PAYPAL, BITCOIN, or even Internet Banking so that the user can select a preferred method of payment.

The reselling platform 206 is provided to help reseller of the system to manage their customers and to monitor their sales activity. Through the reselling platform 206, the reseller can sign up and subscribe plan for their customer. A distributor module can be provided to assist the reseller to build up a reseller network and to provide supports for over sea's resellers.

The cloud service management module of the application server is configured to monitor the activities of each server and data space usage of the user. In the event of the user's data space is fully utilised, the cloud service management module automatically overwrites the oldest images with the new images or communicates with the alert module 211 to send out alert message to the user's mobile device.

The user module 208 is provided to collect contextual data of each signed-in user so that a corresponding user profile can be generated. The user profile may include demographic information, historical traces or purchases, interest, device information, location information, and reviews or inputs of the user. Such user profile can be utilised by the store platform 201 to advertise the most relevant products or services to the user at the right time, location, and situation.

The camera module 203 configured to communicate with at least one camera 110, to retrieve images from the cameras 110, and to store those images into the cloud database 140. If the cameras 110 have an ONVIF standard Pan Tilt Zoom (PTZ) controller, the camera module 203 can further incorporate with an ONVIF module 213 for enabling the user to remotely control the cameras 110. In addition, the IP route module 215 is employed to detect IP addresses of cameras and user devices, and to compare the two IP addresses. If the IP addresses are the same, the connection link of the application server 200 with the user devices is switched to a localhost service for saving bandwidth and enhancing the retrieving speed of the images.

The face recognition 209 and voice recognition 210 modules cooperate with the surveillance cameras 110 to identify a person whose images have been captured by the cameras 110. In the event of detecting an unknown person, the modules will inform the alert module 211 to send out alert messages to the user's devices 120. The modules (209 and 210) may further instruct the alarm module 212 to activate the alarm system of the user.

The web-based server 205 is provided with a graphical user interface (GUI) allowing the user to interactively engage the provided services. Furthermore, the user may also view, stream, or play back the captured images directly from the cameras 110 or from the cloud database 140. The web-based server 205 is incorporated with the codec processing unit 204 so that the web-based server can view, stream, or play back different types of image format. An image convertor can also be provided to convert the format of the retrieved images into a designated format. The load balancing module 216 is implemented to monitor the connectivity of the server 205 with the user devices 120. Also, the load balancing module 216 optimizes the routing of network. All the element of the application is monitored by an administrator platform 207.

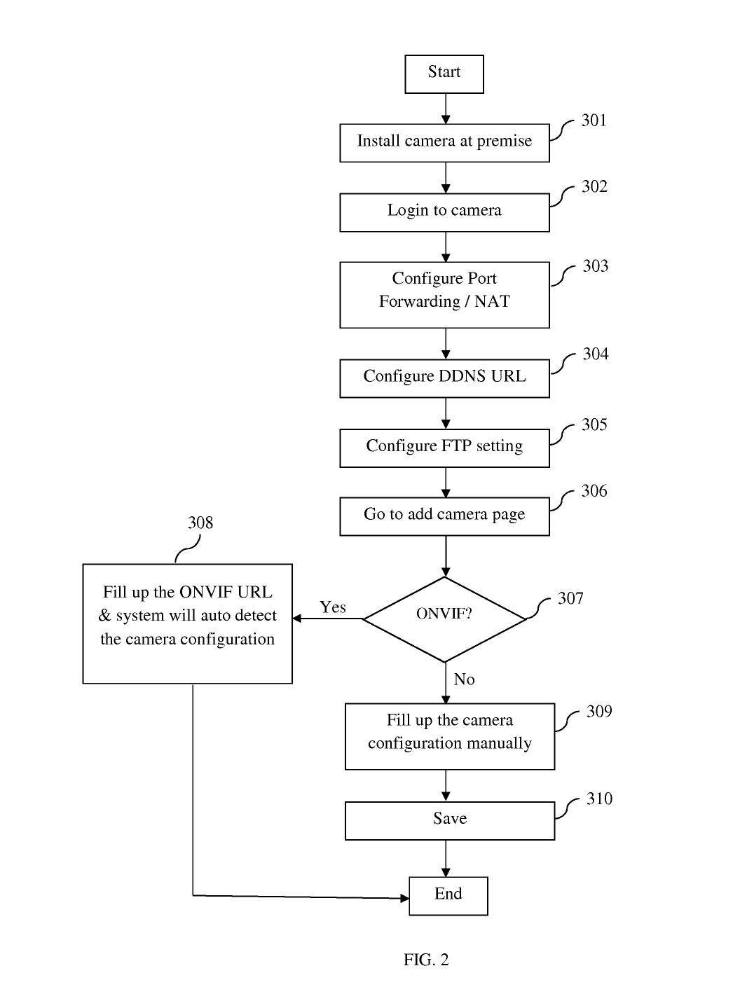

Referring to FIG. 2, the method of connecting the plurality of cameras to the application server is illustrated therein. In step one 301, the cameras are installed at its designated positions. In step two 302, the user log-in to the cameras by inputting their corresponding IP address to the internet browser. In step three 303, the user configures the port forwarding settings or the network address translation (NAT) settings. In step four 304, the user inputs the dynamic domain name system (DDNS) URL. In step five 305, the user configures the file transfer protocol (FTP) settings. The FTP settings include time interval for transferring data, rate and location of the data transfer. In the event of the cameras having the ONVIF standard PTZ controller 307, the user proceed to step six 308 which fills up the ONVIF URL and then the system can automatically detects the camera configuration. On the other hand, the user proceed to step seven 309 which manually fills up the configuration of camera at the web-based server and then save the configuration in step eight 310.

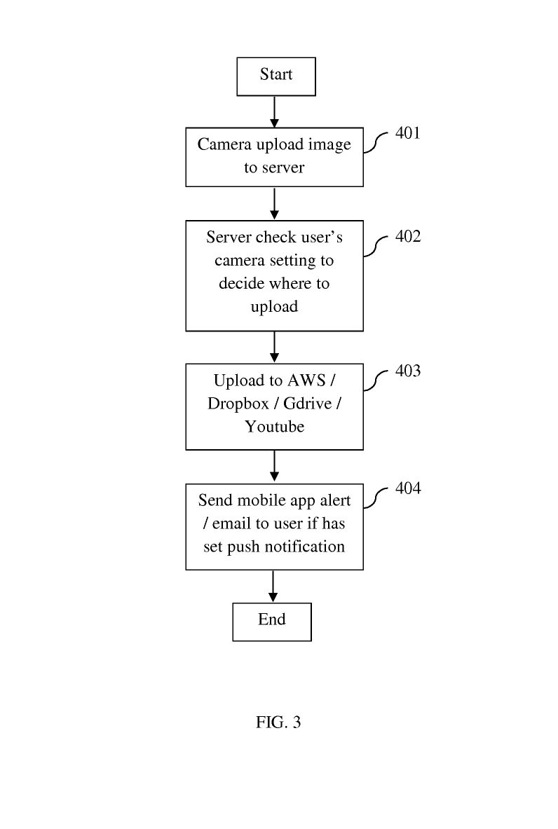

FIG. 3 illustrates the method of uploading image data to the application server. In step one 401, the cameras upload the image data to the server. In step two 402, the application server checks and identifies the settings of the cameras. In step three 403, based on the setting of cameras, the application server stores the image data to a selected cloud database. In step four 404, the application server sends an alert or email to the user devices if the push notification is set to ON.

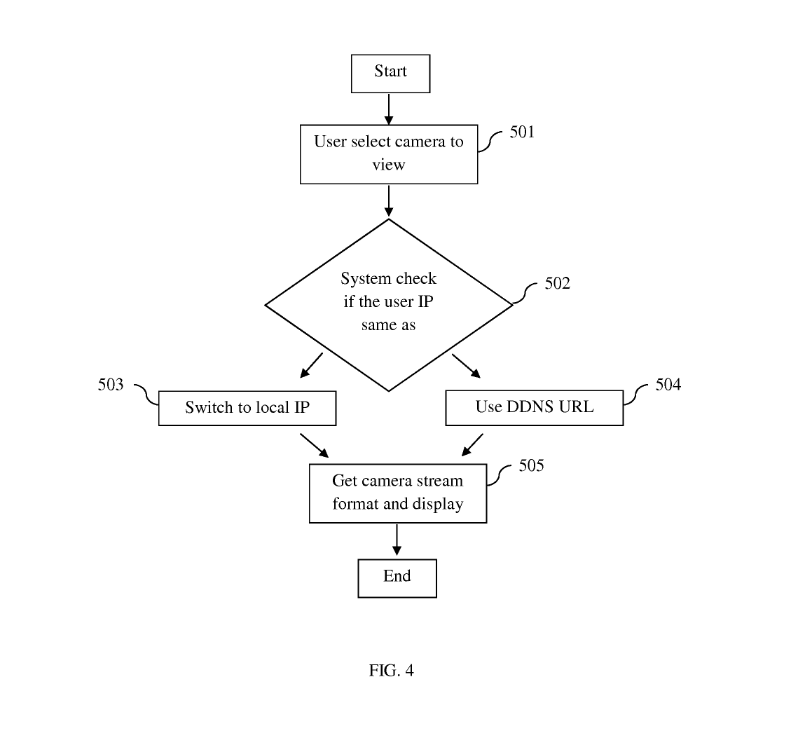

Referring to FIG. 4, the method of streaming image data in real time comprises the following steps. In step one 501, the user selects at least one camera. In step two, application server checks and identifies the IP address of the selected cameras and user devices. In step three 503, the user device is requested by the server to establish a local connection between the user device and the cameras via the localhost to enhance the data transfer speed in the event of the selected cameras and user devices are having the same IP address. In step four 504, the user device retrieves the image data from the application server. In step five 505, the user device streams the retrieved image data in real time.

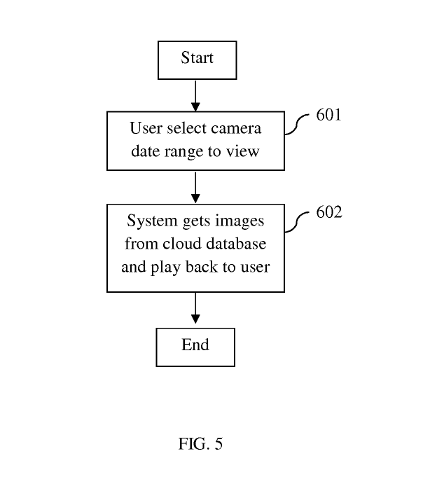

FIG. 5 depicts the method of replaying at least one image data. In step one 601, the user selects at least one camera. In step two 602, the system retrieves the image data from cloud and play back the image data on the web-based server or transmits to the user device.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. An electronic platform system, comprising:
at least one cloud database connected to a communication network;
a store platform connected to the cloud database via the communication network, configured to display a list of products or services for a user to select;
a payment platform connected to the store platform via the communication network, configured to allow the user to make a purchase directly from the store platform; and
an application server connected to the cloud database via the communication network, wherein the application server comprises:
a camera module configured to communicate with at least one camera, retrieve visual or audio data from the camera, store the visual or audio data in the cloud database;
a codec processing unit for encoding or decoding the stored visual or audio data, and
a web server for a computing device of the user to retrieve or display the stored visual or audio data from the cloud database or display the visual or audio data directly from the camera in real time.

2. The electronic platform system according to claim 1, further comprising a reseller platform connected to the cloud database and the store platform via the communication network, configured to allow a reseller to resell or manage the listed products or services.

3. The electronic platform system according to claim 1, further comprising an administrator platform connected to the communication network, configured to manage or maintain the system.

4. The electronic platform system according to claim 1, wherein the store platform includes a product module for listing a plurality of products or services and updating the list of products or services.

5. The electronic platform system according to claim 1, wherein the payment platform includes a billing module for creating and issuing invoice of each purchase of the user, and a payment module connected to a plurality of third party electronic commerce servers for the user to select a designated third party electronic commerce and proceed with the payment.

6. The electronic platform system according to claim 1, wherein the application server further comprises a cloud service management module for monitoring activities of each server and data space usage of the user.

7. The electronic platform system according to claim 1, wherein the application server further comprises a user module for collecting contextual data of the user in real time.

8. The electronic platform system according to claim 1, wherein the application server further comprises a face recognition module for identifying a person who has been captured by the camera.

9. The electronic platform system according to claim 1, wherein the application server further comprises a voice recognition module for identifying the voice of the person who has been captured by the camera.

10. The electronic platform system according to claim 1, wherein the application server further comprises an alert module coupled with the face recognition module or the voice recognition module, configured to send alert message to the mobile device of the user in the event of detecting an unknown person who has been captured by the camera.

11. The electronic platform system according to claim 1, wherein the application server further comprises an alarm module connected to at least one alarm system of the user, configured to trigger the alarm system in the event of detecting an unknown person who has been captured by the camera.

12. The electronic platform system according to claim 1, wherein the application server further comprises an ONVIF module configured to automatically detect configurations of the camera, and to allow the user to remotely control the camera.

13. The electronic platform system according to claim 1, wherein the application server further comprises a motion detector unit coupled with the ONVIF module, configured to transform the camera into a motion detector for detecting movements.

14. The electronic platform system according to claim 1, wherein the application server further comprises a data overwrite module configured to overwrite the stored visual or audio data with the newly retrieved visual or audio data.

15. The electronic platform system according to claim 1, wherein the application server further comprises a social network module connected to a plurality of social networks, configured to allow the user to upload the retrieved visual or audio data to the plurality of social networks, and to display the view of camera in real time.

16. The electronic platform system according to claim 1, wherein the application server further comprises an IP route module configured to detect user IP address, to compare the detected IP address with the camera IP address, and to switch to localhost based on the comparison.

17. The electronic platform system according to claim 1, wherein the application server further comprises a load balancing module for monitoring and optimizing connectivity of the application server with any one of the mobile device, computing device, or camera.

18. The electronic platform system according to any claim 1, wherein the web server of the application server includes a website module for managing the template and settings of the website.

19. The electronic platform system according claim 1, wherein the application server further connects to a mobile application that is installed in a mobile device of the user, the mobile application is configured to display visual or audio data from the cloud database, to communicate with the application server, and to receive alerts from the application server.

20. A method for transferring visual or audio data, comprising the steps of:
connecting, by a user, at least one camera to a communication network;
configuring, by the user, the communication network to establish a connection between the camera and an application server;
inputting, by the user, configurations of the camera to the application server;
retrieving, by the application server, visual or audio data from the camera and storing the retrieved data into the cloud database;
identifying, by the application server, IP address of a computing device of the user; and
establishing, by the application server, a communication link based on the IP address of the computing device and the cameras for the computing device to directly use the camera to over look the view of the camera; and
optionally, transmitting, by the application server, the stored visual or audio data to the computing device.

21. The method according to claim 20, further comprising the steps of:
identifying, by the application server, a person who has been captured by the camera; and
sending an alert message to the computing device of the user in the event the application server detects an unknown person.

22. The method according to claim 20, further comprising the step of:
activating a connected alarm system of the user in the event the application server detects an unknown person.

23. The method according to claim 20, further comprising the step of:
remotely controlling the camera upon the request of the user by an ONVIF module of the application server.

24. The method according to claim 20, further comprising the step of:
providing a codec processing unit to ensure the visual or audio data is displayable.

25. The method according to claim 20, further comprising the step of:
collecting contextual information of the user.

26. The method according to claim 20, wherein the configuration of communication network includes port forwarding, Network address translation (NAT), Dynamic Domain Name System (DDNS), and File Transfer Protocol (FTP).

27. The method according to claim 20, further comprising the step of:
automatically detecting the configuration of the camera before the step of remotely controlling the camera.
